(19) United States
(12) Patent Application Publication
(10) Pub. No.: US 2013/0332764 A1
(43) Pub. Date: Dec. 12, 2013

(54) INTELLIGENT INTER-PROCESSOR COMMUNICATION WITH POWER OPTIMIZATION

(71) Applicant: APPLE INC., Cupertino, CA (US)

(72) Inventors: Ben-Heng Juang, Milpitas, CA (US); Arun G. Mathias, Los Altos, CA (US); Karan Sanghi, Mountain View, CA (US); Arjuna Sivasithambaresan, Santa Clara, CA (US)

(73) Assignee: APPLE INC., Cupertino, CA (US)

(21) Appl. No.: 13/631,360

(22) Filed: Sep. 28, 2012

Related U.S. Application Data
(60) Provisional application No. 61/657,616, filed on Jun. 8, 2012.

(51) Int. Cl. G06F 1/00

(52) U.S. Cl. 713/324; 713/300; 713/320

(57) ABSTRACT

One embodiment of the present invention provides a system that facilitates intelligent inter-processor communication with power optimization. The system comprises a memory, a first router, a second router, a first physical link coupled between the first router and the second router, and a second physical link coupled between the first router and the second router. Furthermore, the system comprises a first communication bus implemented on the first physical link, as well as a second communication bus implemented on the second physical link. Note that the second communication bus provides lower power consumption and lower bandwidth than the first communication bus. During operation, the system receives a packet at the first router, wherein the packet is destined for the second router. Next, the system selects either the first communication bus or the second communication bus over which to route the packet. Finally, the system routes the packet according to the selection.

### RELATED APPLICATION

This application hereby claims priority under 35 U.S.C. §119 to U.S. Provisional Patent Application No. 61/657,616, filed on 8 Jun. 2012, entitled “INTELLIGENT INTER-PROCESSOR COMMUNICATION WITH POWER OPTIMIZATION,” by inventors Ben-Heng Juang, Arun G. Mathias, Karan Sanghi, and Arjuna Sivasithambaresan, having attorney docket number APL-P14687USP1.

### BACKGROUND

1. Field of the Invention

The present invention relates to power-management techniques in computer systems. More specifically, the present invention relates to a method and an apparatus for facilitating intelligent inter-processor communication with power optimization.

2. Related Art

As the processing power of computing devices continues to increase, so does the amount of information that is communicated between processors and other components on these computing devices. Existing inter-processor (or inter-chip) communication loads require a high bandwidth connection to provide high-throughput data transfer. However, a high-bandwidth connection, such as a USB or HSIC system, typically consumes a lot of power, which negatively impacts the battery life. Furthermore, some types of communication require very limited bandwidth, and providing these types of communication over a high-bandwidth connection can waste power.

### SUMMARY

One embodiment of the present invention provides a system that facilitates intelligent inter-processor communication with power optimization. The system comprises a memory, a first router, a second router, a first physical link coupled between the first router and the second router, and a second physical link coupled between the first router and the second router. Furthermore, the system comprises a first communication bus implemented on the first physical link, as well as a second communication bus implemented on the second physical link. Note that the second communication bus provides lower power consumption and lower bandwidth than the first communication bus. During operation, the system receives a packet at the first router, wherein the packet is destined for the second router. Next, the system selects either the first communication bus or the second communication bus over which to route the packet. Finally, the system routes the packet according to the selection.

In some embodiments of the present invention, the system receives a request from an application or service, wherein the request includes bandwidth and/or latency requirements. The system then considers the request when making the selection.

In some embodiments of the present invention, the system monitors network conditions. The system then considers network conditions when making the selection.

In some embodiments of the present invention, the system determines a power status of the apparatus. The system then considers the power status when making the selection.

In some embodiments of the present invention, the system considers bus utilization of the first communication bus and the second communication bus when making the selection.

In some embodiments of the present invention, the system analyzes the packet to determine a packet type. The system then considers the packet type when making the selection.

In some embodiments of the present invention, the system considers the origin application or service when making the selection.

In some embodiments of the present invention, the system places the first communication bus or the second communication bus into a power-saving mode if utilization of the first communication bus or utilization of the second communication bus is below a pre-determined threshold.

In some embodiments of the present invention, the system shuts down the first communication bus or the second communication bus if utilization of the first communication bus or utilization of the second communication bus is below a pre-determined threshold.

In some embodiments of the present invention, the system considers an up status of the first communication bus and the second communication bus when making the selection.

### BRIEF DESCRIPTION OF THE FIGURES

FIG. 1 illustrates a computing environment in accordance with an embodiment of the present invention.

FIG. 2 illustrates a system in accordance with an embodiment of the present invention.

FIG. 3 presents a flow chart illustrating the process of routing packets between chips in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a non-transitory computer-readable storage medium, which may be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed. Note that the term “non-transitory computer-readable storage medium” comprises all computer-readable media, with the sole exception of a propagating electromagnetic signal.

The methods and processes described in the detailed description section can be embodied as code and/or data, which can be stored on a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

One embodiment of the present invention provides a system that facilitates intelligent inter-processor communication with power optimization. The system comprises a memory, a first router, a second router, a first physical link coupled to the first router and the second router, and a second physical link coupled to the first router and the second router. Note that in some embodiments of the present invention, the first router is located on a first chip, and the second router is located on a second chip.

Furthermore, the system comprises a first communication bus implemented on the first physical link, as well as a second communication bus implemented on the second physical link. Note that the second communication bus provides lower power consumption and lower bandwidth than the first communication bus. For example, the first bus might be a Universal Serial Bus (USB) High Speed Inter-Chip (HSIC) bus, while the second bus might be a Universal Asynchronous Receiver/Transmitter (UART) bus. Also note that while embodiments described herein refer to two communication busses, embodiments of the present invention are not meant to be limited to only two communication busses. Any number of communication busses greater than one may be used with embodiments of the present invention.

During operation, the system receives a packet at the first router, wherein the packet is destined for the second router. Next, the system selects either the first communication bus or the second communication bus over which to route the packet. Finally, the system routes the packet according to the selection. Thus, the system can route packets over the least-expensive bus (in terms of power consumption) while still maintaining required performance levels.

In some embodiments of the present invention, the system receives a request from an application or service, wherein the request includes bandwidth and/or latency requirements. The system then considers the request when making the selection. For example, if the application or service notifies the system that it requires a specific throughput or latency, the system can pick a bus that meets the latency and bandwidth requirements of the application or service.

In some embodiments of the present invention, the system monitors network conditions. The system then considers network conditions when making the selection. Note that this can include network conditions outside of the system itself. For example, consider a mobile device with both an application processor and a baseband processor. In this example, the baseband processor and the application processor each contain a router, and the processors are coupled together via several different communication busses with different bandwidth and latency characteristics. If the application processor in this example attempts to upload a large file to a remote service, then it would typically be beneficial for the routers to route the traffic to the baseband processor over a high-bandwidth communication bus to upload the file as quickly as possible. However, if the device itself has a limited-bandwidth connection to the outside world, such as via the EDGE network, then the system might route the file to the baseband processor via a low-bandwidth communication bus because the baseband processor itself is bandwidth-constrained to the outside world.

In some embodiments of the present invention, the system determines a power status of the apparatus. The system then considers the power status when making the selection. For example, if the apparatus is coupled to an external power source and is not running off of internal batteries, then it may be beneficial to always use the bus with the highest available bandwidth. Typically when a device is coupled to an external power source, performance is favored over power savings.

In some embodiments of the present invention, the system considers bus utilization of the first communication bus and the second communication bus when making the selection. For example, if the system is routing a single packet that does not require a high-bandwidth communication bus, then the system would typically route the packet over a low-bandwidth communication bus. However, if the low-bandwidth communication bus is currently in a low-power state to conserve battery power, and a high-bandwidth communication bus is currently delivering packets that require high-bandwidth, then the system can opt to route the single packet over the existing high-bandwidth communication bus rather than activating the low-bandwidth communication bus.

In some embodiments of the present invention, the system analyzes the packet to determine a packet type. The system then considers the packet type when making the selection. For example, if the packet type is a Voice over IP packet, then the system may automatically route the packet over a high-bandwidth communication bus to ensure a quality VoIP connection.

In some embodiments of the present invention, the system considers the origin application or service when making the selection.

In some embodiments of the present invention, the system places the first communication bus or the second communication bus into a power-saving mode if utilization of the first communication bus or utilization of the second communication bus is below a pre-determined threshold.

In some embodiments of the present invention, the system shuts down the first communication bus or the second communication bus if utilization of the first communication bus or utilization of the second communication bus is below a pre-determined threshold. Note that as the routers route traffic via the different communication busses, the system can optimize the traffic over the different communication busses and shut down or activate the different communication busses as needed to conserve power.

In some embodiments of the present invention, the system considers an up status of the first communication bus and the second communication bus when making the selection. For example, as mentioned earlier, if the system is routing a single packet or a small group of packets that do not require a high-bandwidth communication bus, and only a high-bandwidth communication bus is active, then it may be beneficial for the system to route the single packet or the small group of packets over the active high-bandwidth communication bus rather than to activate a low-bandwidth communication bus.

### Computing Environment

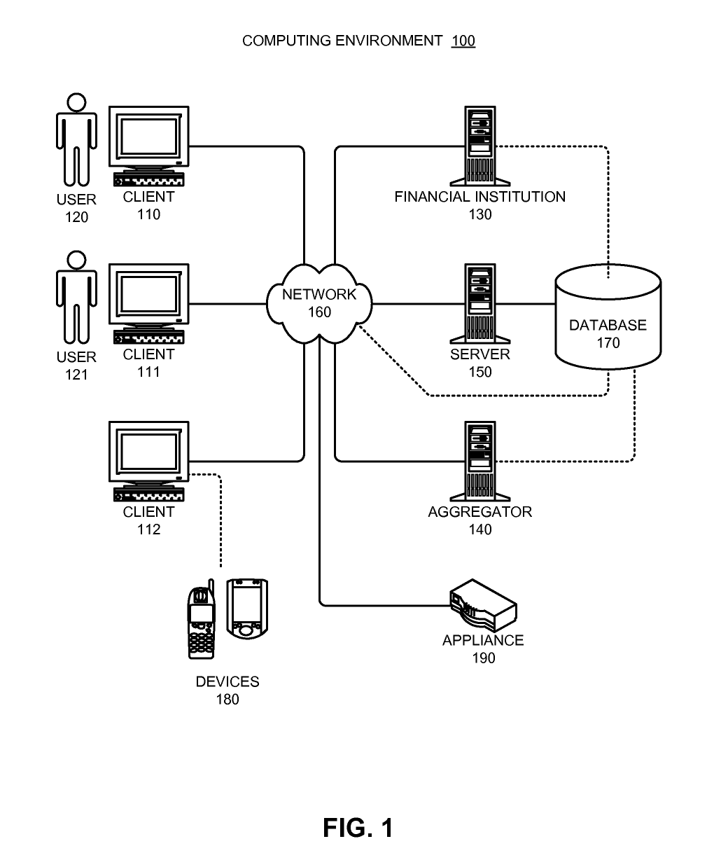

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, servers 130-150, network 160, database 170, devices 180, and appliance 190.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Similarly, servers 130-150 can generally include any node on a network including a mechanism for servicing requests from a client for computational and/or data storage resources. Servers 130-150 can participate in an advanced computing cluster, or can act as stand-alone servers. In one embodiment of the present invention, server 140 is an online “hot spare” of server 150.

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Database 170 can include any type of system for storing data in non-volatile storage. This includes, but is not limited to, systems based upon magnetic, optical, or magneto-optical storage devices, as well as storage devices based on flash memory and/or battery-backed up memory. Note that database 170 can be coupled: to a server (such as server 150), to a client, or directly to a network.

Devices 180 can include any type of electronic device that can be coupled to a client, such as client 112. This includes, but is not limited to, cell phones, personal digital assistants (PDAs), smartphones, personal music players (such as MP3 players), gaming systems, digital cameras, video cameras, portable storage media, or any other device that can be coupled to the client. Note that, in some embodiments of the present invention, devices 180 can be coupled directly to network 160 and can function in the same manner as clients 110-112.

Appliance 190 can include any type of appliance that can be coupled to network 160. This includes, but is not limited to, routers, switches, load balancers, network accelerators, and specialty processors. Appliance 190 may act as a gateway, a proxy, or a translator between server 140 and network 160.

Note that different embodiments of the present invention may use different system configurations, and are not limited to the system configuration illustrated in computing environment 100. In general, any device that is capable of communicating via network 160 may incorporate elements of the present invention.

### System

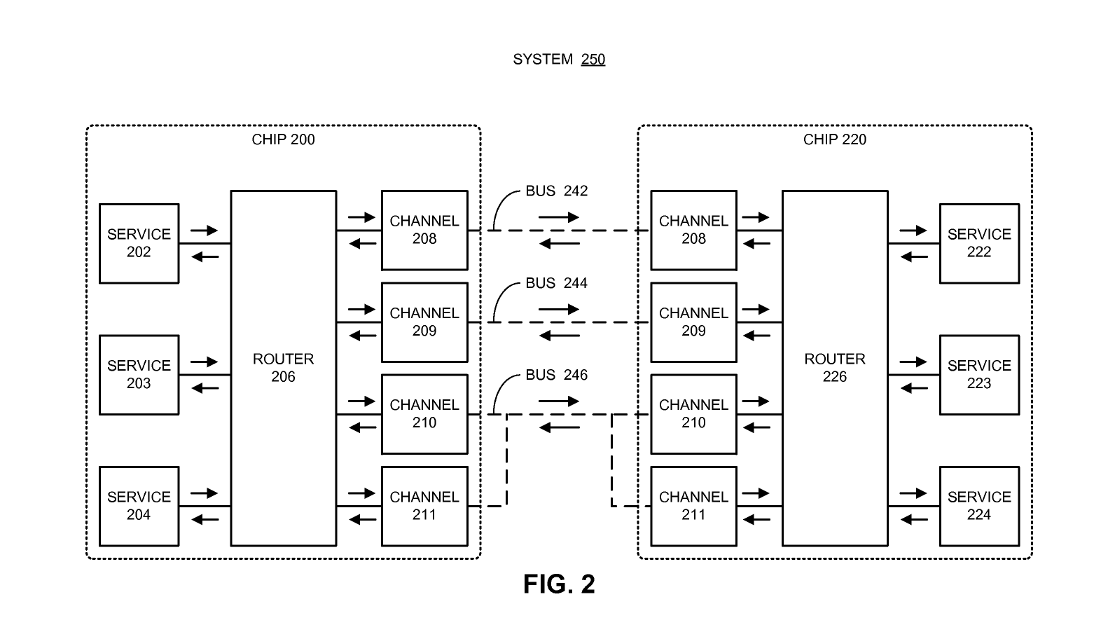

FIG. 2 illustrates system 250 in accordance with an embodiment of the present invention. As illustrated in FIG. 2, system 250 can comprise chip 200 and chip 220. Chip 200 and chip 220 can comprise various types of chips and processors. For example, in one embodiment, chip 200 is a baseband processor and chip 220 is an application processor.

Chip 200 is coupled to chip 220 via multiple busses, such as busses 242-246. Each bus implements various communication channels. For example, bus 242 implements channel 208, bus 244 implements channel 209, and bus 246 implements channels 210 and 211. Note that, as described previously, busses 242-246 may comprise different bandwidth and latency characteristics. For example, bus 242 may be a USB HSIC bus, while bus 244 may be a UART bus. Also note that a bus may implement any number of channels.

Executing on chip 200 are services 202-204 which make read/write calls to router 206. Router 206 then determines which bus 242-246 over which to route packets from services 202-204. Likewise, executing on chip 220 are services 222-224 which make read/write calls to router 226. Router 226 then determines which bus 242-246 over which to route packets from services 222-224.

Routine Packets between Chips

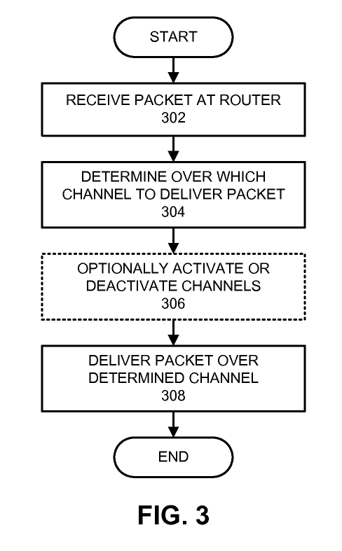

FIG. 3 presents a flow chart illustrating the process of routing packets between chips in accordance with an embodiment of the present invention. During operation, system 250 receives a packet at router 206 from service 202 that is destined to service 224 on chip 220 (operation 302). Next, system 250 determines which communication bus in busses 242-246 to deliver the packet to chip 220 (operation 304). Note that, as described previously, router 206 may consider many different parameters when determining a route for the packet. For example, router 206 may consider external network traffic to system 250, status and congestion of busses 242-246, and requirements of service 202.

Optionally, router 206 may activate or deactivate channels 208-211 to conserve power (operation 306). Finally, router 206 delivers the packet over the determined channel (operation 308) to router 226, which hands off the packet to service 224.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus configured to facilitate intelligent inter-processor communication with power optimization, comprising:
a memory;
a first router;
a second router;
a first physical link coupled between the first router and the second router;
a second physical link coupled between the first router and the second router;
a first communication bus implemented on the first physical link;
a second communication bus implemented on the second physical link, wherein the second communication bus provides lower power consumption and lower bandwidth than the first communication bus;
a receiving mechanism configured to receive a packet at the first router, wherein the packet is destined for the second router;
a selection mechanism configured to select either the first communication bus or the second communication bus over which to route the packet; and
a routing mechanism configured to route the packet according to the selection.

2. The apparatus of claim 1:
wherein the receiving mechanism receives a request from an application or service, wherein the request includes bandwidth and/or latency requirements; and
wherein the selection mechanism considers the request when making the selection.

3. The apparatus of claim 1, further comprising:
a monitoring mechanism configured to monitor network conditions; and
wherein the selection mechanism considers network conditions when making the selection.

4. The apparatus of claim 1, further comprising:
a power status mechanism configured to indicate a power status of the apparatus; and
wherein the selection mechanism considers the power status when making the selection.

5. The apparatus of claim 1, wherein the selection mechanism considers bus utilization of the first communication bus and the second communication bus when making the selection.

6. The apparatus of claim 1, further comprising:
a packet-analysis mechanism configured to analyze the packet to determine a packet type; and
wherein the selection mechanism considers the packet type when making the selection.

7. The apparatus of claim 1, wherein the selection mechanism considers the origin application or service when making the selection.

8. The apparatus of claim 1, further comprising a power-saving mechanism configured to place the first communication bus or the second communication bus into a power-saving mode if utilization of the first communication bus or utilization of the second communication bus is below a pre-determined threshold.

9. The apparatus of claim 1, further comprising a power-saving mechanism configured to shut down the first communication bus or the second communication bus if utilization of the first communication bus or utilization of the second communication bus is below a pre-determined threshold.

10. The apparatus of claim 1, wherein the selection mechanism considers an up status of the first communication bus and the second communication bus when making the selection.

11. A computer-implemented method that facilitates intelligent inter-processor communication with power optimization, the method comprising:
receiving, by computer at a first router, a packet that is destined for a second router;
selecting, by computer, either a first communication bus or a second communication bus over which to route the packet, wherein the second communication bus provides lower power consumption and lower bandwidth than the first communication bus; and
routing, by computer, the packet according to the selection.

12. The computer-implemented method of claim 11, further comprising:
receiving a request from an application or service, wherein the request includes bandwidth and/or latency requirements; and
considering the request when making the selection.

13. The computer-implemented method of claim 11, further comprising:
monitoring network conditions; and
considering network conditions when making the selection.

14. The computer-implemented method of claim 11, further comprising:
determining a power status of the apparatus; and
considering the power status when making the selection.

15. The computer-implemented method of claim 11, further comprising considering bus utilization of the first communication bus and the second communication bus when making the selection.

16. The computer-implemented method of claim 11, further comprising:
analyzing the packet to determine a packet type; and
considering the packet type when making the selection.

17. The computer-implemented method of claim 11, further comprising considering the origin application or service when making the selection.

18. The computer-implemented method of claim 11, further comprising placing the first communication bus or the second communication bus into a power-saving mode if utilization of the first communication bus or utilization of the second communication bus is below a pre-determined threshold.

19. The computer-implemented method of claim 11, further comprising shutting down the first communication bus or the second communication bus if utilization of the first communication bus or utilization of the second communication bus is below a pre-determined threshold.

20. The computer-implemented method of claim 11, further comprising considering an up status of the first communication bus and the second communication bus when making the selection.

21. A non-transitory computer-readable storage medium storing instructions that when executed by a computer cause the computer to perform a method that facilitates intelligent inter-processor communication with power optimization, the method comprising:
receiving, by computer at a first router, a packet that is destined for a second router;
selecting, by computer, either a first communication bus or a second communication bus over which to route the packet, wherein the second communication bus provides lower power consumption and lower bandwidth than the first communication bus; and
routing, by computer, the packet according to the selection.

22. The non-transitory computer-readable storage medium of claim 21, wherein the method further comprises:
receiving a request from an application or service, wherein the request includes bandwidth and/or latency requirements; and
considering the request when making the selection.

23. The non-transitory computer-readable storage medium of claim 21, wherein the method further comprises:
monitoring network conditions; and
considering network conditions when making the selection.

24. The non-transitory computer-readable storage medium of claim 21, wherein the method further comprises:
determining a power status of the apparatus; and
considering the power status when making the selection.

25. The non-transitory computer-readable storage medium of claim 21, wherein the method further comprises considering bus utilization of the first communication bus and the second communication bus when making the selection.

26. The non-transitory computer-readable storage medium of claim 21, wherein the method further comprises:
analyzing the packet to determine a packet type; and
considering the packet type when making the selection.

27. The non-transitory computer-readable storage medium of claim 21, wherein the method further comprises considering the origin application or service when making the selection.

28. The non-transitory computer-readable storage medium of claim 21, wherein the method further comprises placing the first communication bus or the second communication bus into a power-saving mode if utilization of the first communication bus or utilization of the second communication bus is below a pre-determined threshold.

29. The non-transitory computer-readable storage medium of claim 21, wherein the method further comprises shutting down the first communication bus or the second communication bus if utilization of the first communication bus or utilization of the second communication bus is below a pre-determined threshold.

30. The non-transitory computer-readable storage medium of claim 21, wherein the method further comprises considering an up status of the first communication bus and the second communication bus when making the selection.
